(19) United States
(12) Patent Application Publication
(10) Pub. No.: US 2023/0284014 A1
(43) Pub. Date: Sep. 7, 2023

(54) WIRELESS COMMUNICATION DEVICE, AND SYSTEM

(71) Applicant: KABUSHIKI KAISHA TOKAI RIKA DENKI SEISAKUSHO, Aichi (JP)

(72) Inventors: Yosuke HASEGAWA, Aichi (JP); Masateru FURUTA, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 18/018,061

(22) PCT Filed: May 7, 2021
(86) PCT No.: PCT/JP2021/017467

§ 371 Date: Jan. 26, 2023

(30) Foreign Application Priority Data
Sep. 28, 2020 (JP) 2020-161582

(51) Int. Cl. H04W 12/06; H04W 12/63

(52) U.S. Cl. CPC H04W 12/06; H04W 12/63

(57) ABSTRACT

There is provided a wireless communication device, including a first wireless communication unit that performs first wireless communication with another communication device, the first wireless communication selectively using a plurality of channels complying with a first communication standard, a second wireless communication unit that performs second wireless communication with the another communication device, the second wireless communication complying with a second communication standard different from the first communication standard, and a control unit that controls the first wireless communication by the first wireless communication unit and the second wireless communication by the second wireless communication unit, in which the control unit controls the second wireless communication unit to start standby for receiving a signal used for the second wireless communication after a specified period of time, on the basis of reception of a connection request related to the first wireless communication by the first wireless communication unit.

### TECHNICAL FIELD

The present invention relates to a wireless communication device, a system, and a program.

### BACKGROUND ART

Recently, there has been developed a technology of performing authentication in accordance with results of transmission and reception of wireless signals between devices. For example, the following Patent Literature 1 discloses a system in which an on-vehicle device performs authentication of a portable device by transmitting and receiving signals to and from the portable device and controls the vehicle in accordance with the result of the authentication.

### CITATION LIST

### Patent Literature

Patent Literature 1: JP 2018-71190

### SUMMARY OF INVENTION

### Technical Problem

In the above-described system, there is performed distance measurement in which a distance between the on-vehicle device and the portable device is calculated on the basis of wireless communication, and the calculated distance measurement value is used for authentication. In order to perform such distance measurement, it is required to put either the on-vehicle device or the portable device on standby in a state allowing the reception of a signal. However, as such standby time is longer, the power consumption is increased.

In view of the above-described problem, the present invention aims at effectively reducing power consumption required during signal reception standby.

### Solution to Problem

In order to solve the above-described problem, an aspect of the present invention provides a wireless communication device, including a first wireless communication unit that performs first wireless communication with another communication device, the first wireless communication selectively using a plurality of channels complying with a first communication standard, a second wireless communication unit that performs second wireless communication with the another communication device, the second wireless communication complying with a second communication standard different from the first communication standard, and a control unit that controls the first wireless communication by the first wireless communication unit and the second wireless communication by the second wireless communication unit, in which the control unit controls the second wireless communication unit to start standby for receiving a signal used for the second wireless communication after a specified period of time, on the basis of reception of a connection request related to the first wireless communication by the first wireless communication unit.

Moreover, in order to solve the above-described problem, another aspect of the present invention provides a wireless communication device, including a first wireless communication unit that performs first wireless communication with another communication device, the first wireless communication selectively using a plurality of channels complying with a first communication standard, a second wireless communication unit that performs second wireless communication with the another communication device, the second wireless communication complying with a second communication standard different from the first communication standard, and a control unit that controls the first wireless communication by the first wireless communication unit and the second wireless communication by the second wireless communication unit, in which the control unit controls timing at which the second wireless communication unit is controlled to transmit a signal used for the second wireless communication, on the basis of timing information received by the first wireless communication unit after the first wireless communication unit is controlled to transmit a connection request related to the first wireless communication.

Moreover, in order to solve the above-described problem, another aspect of the present invention provides a system, including a first wireless communication device, and a second wireless communication device, in which the first wireless communication device includes a first wireless communication unit that performs first wireless communication with the second communication device, the first wireless communication selectively using a plurality of channels complying with a first communication standard, a second wireless communication unit that performs second wireless communication with the second communication device, the second wireless communication complying with a second communication standard different from the first communication standard, and a control unit that controls the first wireless communication by the first wireless communication unit and the second wireless communication by the second wireless communication unit, in which the control unit controls the second wireless communication unit to start standby for receiving a signal used for the second wireless communication after a specified period of time, and controls the first wireless communication unit to transmit timing information specifying timing at which the second wireless communication device transmits a signal used for the second wireless communication, on the basis of reception of a connection request related to the first wireless communication by the first wireless communication unit, and the second wireless communication device controls timing at which the signal used for the second wireless communication is transmitted, on the basis of the received timing information.

Moreover, in order to solve the above-described problem, another aspect of the present invention provides a program, the program controlling a computer to achieve a first wireless communication function that performs first wireless communication with another communication device, the first wireless communication selectively using a plurality of channels complying with a first communication standard, a second wireless communication function that performs second wireless communication with the another communication device, the second wireless communication complying with a second communication standard different from the first communication standard, and a control function that controls the first wireless communication by the first wireless communication function and the second wireless communication by the second wireless communication function, in which the control function is controlled to control the second wireless communication function to start standby for receiving a signal used for the second wireless communication after a specified period of time, on the basis of reception of a connection request related to the first wireless communication by the first wireless communication function.

Moreover, in order to solve the above-described problem, another aspect of the present invention provides a program, the program controlling a computer to achieve a first wireless communication function that performs first wireless communication with another communication device, the first wireless communication selectively using a plurality of channels complying with a first communication standard, a second wireless communication function that performs second wireless communication with the another communication device, the second wireless communication complying with a second communication standard different from the first communication standard, and a control function that controls the first wireless communication by the first wireless communication function and the second wireless communication by the second wireless communication function, in which the control function is controlled to control timing at which the second wireless communication function is controlled to transmit a signal used for the second wireless communication, on the basis of timing information received by the first wireless communication function after the first wireless communication function is controlled to transmit a connection request related to the first wireless communication.

### Advantageous Effects of Invention

As described above, in the present invention, it is possible to effectively reduce power consumption required during signal reception standby.

### BRIEF DESCRIPTION OF DRAWINGS

FIG. 1 is a block diagram illustrating a configuration example of a system 1 according to an embodiment of the present invention.

FIG. 2 is a sequence diagram illustrating an example of a flow of operations by a comparison system according to the embodiment.

FIG. 3 is a sequence diagram illustrating an example of a flow of operations by the system 1 according to the embodiment.

FIG. 4 is a flowchart illustrating an example of a flow of control on a controlled device by a control unit 130 of an on-vehicle device 10 according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. EMBODIMENT

### 1.1. System Configuration Example

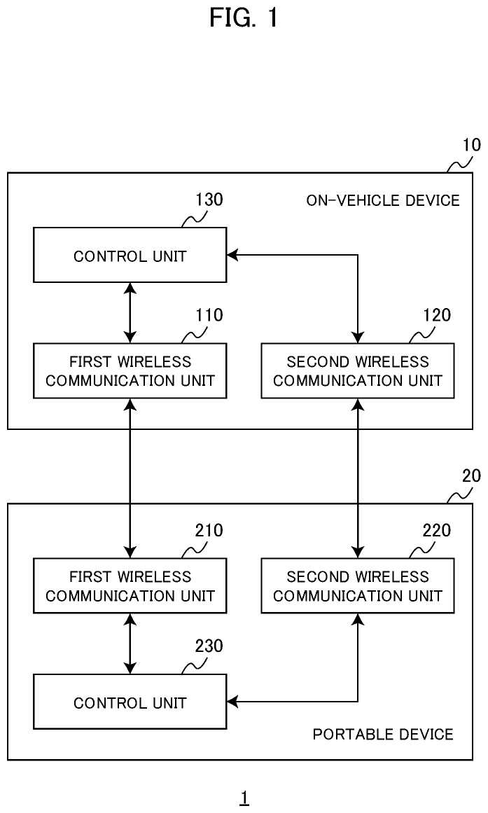

First, there will be described a configuration example of the system 1 according to an embodiment of the present invention. FIG. 1 is a block diagram illustrating a configuration example of the system 1 according to the embodiment. As illustrated in FIG. 1, the system 1 of the embodiment includes the on-vehicle device and a portable device 20.

(On-Vehicle Device 10)

First, a functional configuration of the on-vehicle device 10 according to the embodiment will be described. The on-vehicle device 10 of the embodiment is an example of the wireless communication device provided in a mobile body such as a vehicle.

As illustrated in FIG. 1, the on-vehicle device 10 of the embodiment includes a first wireless communication unit 110, a second wireless communication unit 120, and a control unit 130.

(First Wireless Communication Unit 110)

The first wireless communication unit 110 of the embodiment performs the first wireless communication with the portable device 20, the first wireless communication selectively using a plurality of channels complying with a first communication standard.

An example of the above-described first communication standard is the Bluetooth (Registered Trademark) low energy (BLE) communication standard.

In a case where the BLE communication standard is adopted as the first communication standard, the first wireless communication unit 110 of the embodiment performs BLE communication as the first wireless communication with the portable device 20.

For example, the first wireless communication unit 110 of the embodiment receives a connection request related to the first wireless communication that is transmitted by the portable device 20.

Moreover, the first wireless communication unit 110 of the embodiment transmits a connection acknowledgement in response to the connection request, in accordance with the control by the control unit 130.

(Second Wireless Communication Unit 120)

The second wireless communication unit 120 of the embodiment performs second wireless communication with the portable device 20, the second wireless communication complying with a second communication standard different from a first communication standard.

An example of the above-described second communication standard is the ultra wide band (UWB) communication standard.

In a case where the UWB communication standard is adopted as the second communication standard, the second wireless communication unit 120 of the embodiment performs UWB communication as the second wireless communication with the portable device 20.

For example, the second wireless communication unit 120 of the embodiment receives a signal used for the second wireless communication that is transmitted by the portable device 20.

An example of the above-described signal is a first distance measurement signal used for distance measurement for estimating a distance between the on-vehicle device 10 and the portable device 20 (more precisely, between the second wireless communication unit 120 provided in the on-vehicle device 10 and a second wireless communication unit 220 provided in the portable device 20).

The second wireless communication unit 120 of the embodiment transmits the second distance measurement signal in response to the received first distance measurement signal, in accordance with the control by the control unit 130.

Note that in the following, the explanation will be given using, as a main example, the case where the second wireless communication standard of the embodiment is the UWB communication standard. However, the second wireless communication standard of the embodiment is not limited to such an example. The second wireless communication standard of the embodiment may be various kinds of communication standard allowing transmission and reception of signals used for distance measurement.

(Control Unit 130)

The control unit 130 of the embodiment controls the components of the on-vehicle device 10.

For example, the control unit 130 of the embodiment controls the first wireless communication by the first wireless communication unit 110 and the second wireless communication by the second wireless communication unit 120.

Here, the control unit 130 of the embodiment is characterized in controlling the second wireless communication unit 120 to start standby for receiving a signal used for the second wireless communication after a specified period of time, on the basis of the reception of a connection request related to the first wireless communication by the first wireless communication unit 110.

The functions of the control unit 130 of the embodiment will be separately described in detail.

Note that the functions of the control unit 130 of the embodiment are achieved by a processor such as a CPU.

The above has described the functional configuration example of the on-vehicle device 10 of the embodiment. Note that the above-described functional configuration is merely an example, and the functional configuration of the on-vehicle device 10 of the embodiment is not limited thereto. The functional configuration of the on-vehicle device 10 of the embodiment can be modified flexibly depending on specifications and uses.

(Portable Device 20)

The following will describe a functional configuration example of the portable device 20 according to the embodiment. The portable device 20 of the embodiment is an example of the wireless communication device carried by a user using a mobile body such as a vehicle in which the on-vehicle device 10 is provided. The portable device 20 of the embodiment may be, for example, a smartphone or a dedicated device, for example.

As illustrated in FIG. 1, the portable device 20 of the embodiment includes a first wireless communication unit 210, the second wireless communication unit 220, and a control unit 230.

(First Wireless Communication Unit 210)

The first wireless communication unit 210 of the embodiment performs the first wireless communication with the on-vehicle device 10, the first wireless communication selectively using a plurality of channels complying with the first communication standard.

As described above, the first wireless communication of the embodiment may be BLE communication.

In this case, the first wireless communication unit 210 of the embodiment may transmit a connection request related to the first wireless communication, in accordance with the control by the control unit 230.

Moreover, the first wireless communication unit 210 of the embodiment may receive a connection acknowledgement that is transmitted by the on-vehicle device 10 in response to the above-described connection request.

Furthermore, the first wireless communication unit 210 of the embodiment may receive timing information that specifies timing at which a signal used for the second wireless communication is transmitted.

(Second Wireless Communication Unit 220)

The second wireless communication unit 220 of the embodiment performs the second wireless communication with the portable device 20, the second wireless communication complying with the second communication standard.

As described above, the second wireless communication of the embodiment may be UWB communication.

For example, the second wireless communication unit 220 of the embodiment may transmit a first distance measurement signal, in accordance with the control by the control unit 230.

Moreover, for example, the second wireless communication unit 220 of the embodiment may receive a second distance measurement signal that is transmitted by the on-vehicle device 10 in response to the above-described first distance measurement signal.

(Control Unit 230)

The control unit 230 of the embodiment controls the components of the on-vehicle device 20.

For example, the control unit 230 of the embodiment controls the first wireless communication by the first wireless communication unit 210 and the second wireless communication by the second wireless communication unit 220.

Here, the control unit 230 of the embodiment is characterized in controlling the timing at which the second wireless communication unit 220 transmits a signal used for the second wireless communication, on the basis of the timing information received by the first wireless communication unit 210 after the first wireless communication unit 210 is controlled to transmit a connection request related to the first wireless communication.

The functions of the control unit 230 of the embodiment will be separately described in detail.

Note that the functions of the control unit 230 of the embodiment are achieved by a processor such as a CPU.

The above has described the functional configuration example of the portable device 20 of the embodiment. Note that the above-described functional configuration is merely an example, and the functional configuration of the portable device 20 according to the embodiment is not limited thereto. For example, the portable device 20 may further include an operation part that receives operations by a user, a display unit that displays various kinds of information, and the like. The functional configuration of the portable device 20 of the embodiment can be modified flexibly depending on specifications and uses.

<<1.2. Details of Operations>>

The following will specifically describe operations of the system 1 according to the embodiment.

In order to explain the effects of the system 1 according to the embodiment, an example will be given first regarding the operations by a comparison system that performs general communication control.

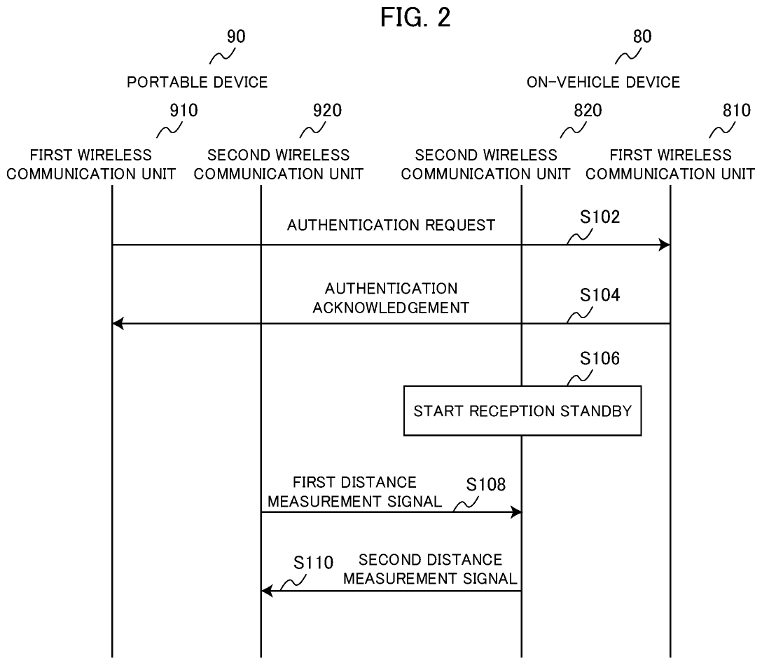

FIG. 2 is a sequence diagram illustrating an example of a flow of operations by the comparison system.

Note that in the example illustrated in FIG. 2, the comparison system includes an on-vehicle device 80 and a portable device 90. Moreover, the on-vehicle device 80 includes a first wireless communication unit 810, a second wireless communication unit 820, and a control unit 830 (not illustrated). Moreover, the portable device 90 includes a first wireless communication unit 910, a second wireless communication unit 920, and a control unit 930 (not illustrated).

In the case of the example illustrated in FIG. 2, the wireless communication unit 910 of the portable device 90 transmits an authentication request (S102).

The above-described authentication request may be a signal requesting the on-vehicle device 80 to perform authentication of the portable device 90.

Moreover, the first wireless communication unit 810 of the on-vehicle device 80 transmits an authentication acknowledgement in response to the authentication request received at Step S102 (S104).

The above-described authentication acknowledgement may be a signal notifying of the authentication of the portable device 90 to be performed, or may be a signal requesting the transmission of information necessary for the authentication (such as an identifier of the portable device 90, for example).

In the case of the example illustrated in FIG. 2, the second wireless communication unit 820 of the on-vehicle device 80 starts standby for receiving the first distance measurement signal (S106), on the basis of the transmission of the authentication acknowledgement by the first wireless communication unit 810 at step S104.

Thereafter, the second wireless communication unit 820 of the on-vehicle device 80 receives the first distance measurement signal transmitted by the second wireless communication unit 920 of the portable device 90 (S108), and transmits the second distance measurement signal in response to such a first distance measurement signal (S110).

The above has described the flow of the operations by the comparison system with the use of an example.

In the case of the example illustrated in FIG. 2, the second wireless communication unit 820 of the on-vehicle device 80 starts standby for receiving the first distance measurement signal, on the basis of the transmission of the authentication acknowledgement by the first wireless communication unit 810.

However, in the sequence as described above, the on-vehicle device 80 is not able to grasp time required from the reception of the authentication acknowledgement by the first wireless communication unit 910 of the portable device 90 to the transmission of the first distance measurement signal by the second wireless communication unit 920.

For this reason, the on-vehicle device 80 needs to control the second wireless communication unit 820 to start standby at early timing so that the portable device 90 can transmit the first distance measurement signal at any time.

In this case, the standby time of the second wireless communication unit 820 provided in the on-vehicle device 80 tends to be long, and the power consumption may increase as the standby time is longer.

The technical idea of the present invention has been made in view of the above-described aspects, and is capable of effectively reducing power consumption required during signal reception standby.

The following will specifically describe operations of the system 1 according to the embodiment achieving the above.

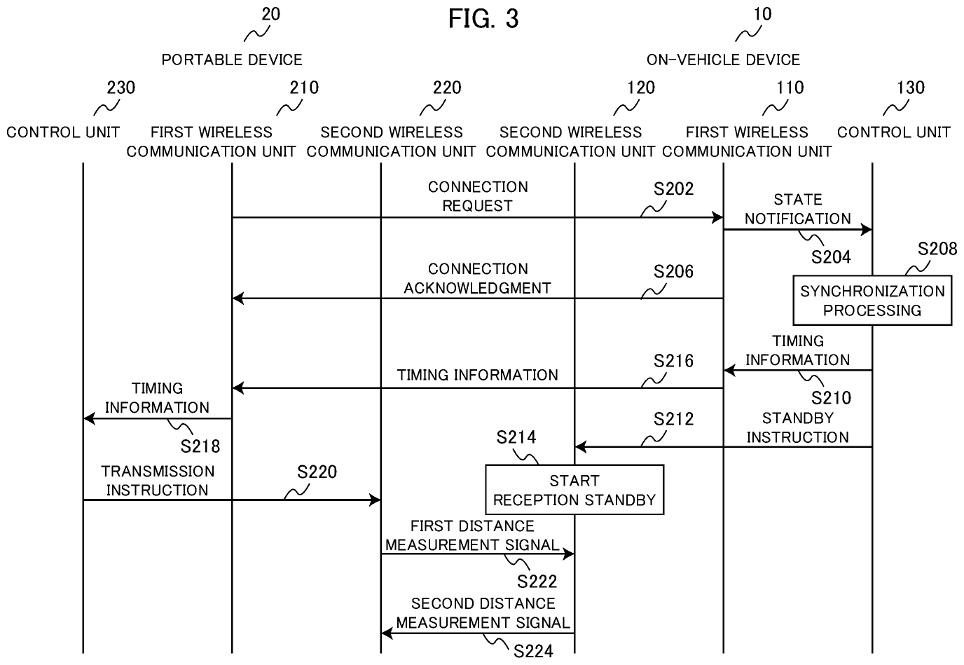

FIG. 3 is a sequence diagram illustrating an example of a flow of operations by the system 1 according to the embodiment.

In the case of the example illustrated in FIG. 3, the wireless communication unit 210 of the portable device 20 first transmits a connection request (S202).

Note that prior to the transmission of the connection request at Step S202, the first wireless communication unit 110 of the on-vehicle device 10 may transmit an advertisement, or the first wireless communication unit 210 of the portable device 20 may scan an advertisement.

Next, the first wireless communication unit 110 of the on-vehicle device 10 outputs a state notification indicating that a connection request has been received to the control unit 130 (S204), on the basis of the reception of the connection request at Step S202.

Moreover, the first wireless communication unit 110 of the on-vehicle device transmits a connection acknowledgement to the first wireless communication unit 210 of the portable device 20 in response to the connection request received at Step S202 (S206).

Meanwhile, the control unit 130 of the on-vehicle device 10 performs synchronization processing on the basis of the state notification input at Step S204 (S208).

The above-described synchronization processing may be processing for matching the timing at which the second wireless communication unit 220 of the portable device 20 transmits the first distance measurement signal with the timing at which the second wireless communication unit 120 of the on-vehicle device 10 starts standby for receiving the first distance measurement signal.

The control unit 130 of the on-vehicle device 10 outputs the timing information generated in the synchronization processing at Step S208 to the first wireless communication unit 110 (S210), and controls the first wireless communication unit 110 to transmit the timing information (S212).

The control unit 130 of the on-vehicle device 10 may control the first wireless communication unit 110 to transmit the timing information using a channel different from the channel used for the transmission of the connection request at Step S202.

Here, the above-described timing information may be information that specifies the timing at which the second wireless communication unit 220 of the portable device 20 transmits a signal used for the second wireless communication (a first distance measurement signal, for example).

The first wireless communication unit 210 of the portable device 20 having received the timing information at Step S216, outputs the timing information to the control unit 230 (S218).

Moreover, the control unit 130 of the on-vehicle device 10 outputs a standby instruction that specifies the timing for starting standby for receiving the first distance measurement signal to the second wireless communication unit 120 (S212), concurrently with outputting the timing information to the first wireless communication unit 110 at Step S210.

On the basis of the standby instruction input at Step S212, the second wireless communication unit 120 of the on-vehicle device 10 starts standby for receiving the first distance measurement signal after the specified period of time specified in such a standby instruction has elapsed (S214).

Meanwhile, the control unit 230 of the portable device 20 to which the timing information has been input at Step S218, outputs a transmission instruction related to the first distance measurement signal to the second wireless communication unit 220, on the basis of such timing information (S220).

The above-described transmission instruction may be a control signal for controlling the second wireless communication unit 220 to transmit the first distance measurement signal at the timing specified in the timing information.

Moreover, the wireless communication unit 220 of the portable device 20 transmits the first distance measurement signal, on the basis of the transmission instruction input at Step S220 (Step S222).

Next, the control unit 130 of the on-vehicle device 10 controls the second wireless communication unit 120 to transmit the second distance measurement signal in response to the first distance measurement signal received by the second wireless communication unit 120 at Step S222 (S224).

The above has described an example of the flow of the operations by the system 1 according to the embodiment. With the flow described above, it is possible to match the timing at which the second wireless communication unit 220 of the portable device 20 transmits the first distance measurement signal with the timing at which the second wireless communication unit 120 of the on-vehicle device 10 starts standby for receiving the first distance measurement signal.

Moreover, in this manner, it is possible to effectively reduce the standby time for the second wireless communication unit 120 of the on-vehicle device 10, and reduce the power consumption required for standby.

Note that the control unit 130 of the on-vehicle device 10 according to the embodiment may perform authentication based on the first wireless communication, distance measurement based on the second wireless communication, and a control on a controlled device based on the authentication and distance measurement, after the flow of operations illustrated in FIG. 3, or partially concurrently with the flow of operations illustrated in FIG. 3.

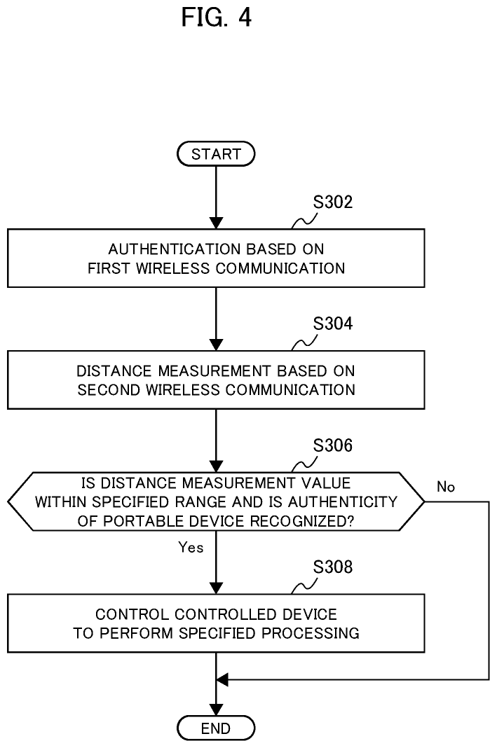

FIG. 4 is a flowchart illustrating an example of a flow of control on a controlled device by the control unit 130 of the on-vehicle device 10 according to the embodiment.

In the example illustrated in FIG. 4, the control unit 130 of the on-vehicle device 10 first performs authentication based on the first wireless communication (S302).

The control unit 130 of the on-vehicle device 10 may perform the above-described authentication on the basis of a first authentication signal and a second authentication signal that are transmitted and received between the first wireless communication unit 110 of the on-vehicle device 10 and the first wireless communication unit 210 of the portable device 20, for example, after the transmission and reception of the connection request and the connection acknowledgement illustrated in FIG. 3.

In this case, the control unit 130 of the on-vehicle device 10 may control the first wireless communication unit 110 to transmit the first authentication signal, and the control unit 230 of the portable device 20 may control the first wireless communication unit 210 to transmit the second authentication signal in response to the first authentication signal.

For example, the first authentication signal may be a signal requesting an identifier of the portable device 20. In this case, the second authentication signal may be a signal including the above-described identifier.

Moreover, for example, the first authentication signal may be a signal including a random number or the like. In this case, the second authentication signal may be a signal including a calculation result (for example, a hash value calculated using a hash function) calculated using the above-described random number and preliminarily shared key information.

The control unit 130 of the on-vehicle device 10 according to the embodiment may perform authentication of the portable device 20 on the basis of the first authentication signal and the second authentication signal as described above.

Moreover, the control unit 130 of the on-vehicle device 10 according to the embodiment performs distance measurement based on the second wireless communication (S304).

To be more specific, the control unit 130 of the on-vehicle device 10 according to the embodiment may perform distance measurement based on the first distance measurement signal and the second distance measurement signal transmitted and received between the second wireless communication unit 120 of the on-vehicle device 10 and the second wireless communication unit 220 of the portable device 20.

The control unit 130 of the on-vehicle device 10 is able to calculate a distance measurement value that is an estimation value of the distance between the on-vehicle device 10 and the portable device 20 (more precisely between the second wireless communication unit 120 of the on-vehicle device 10 and the second wireless communication unit 220 of the portable device 20), on the basis of the time ΔT1 from the time at which the second wireless communication unit 220 of the portable device transmits the first distance measurement signal to the time at which it receives the second distance measurement signal, and the time ΔT2 from the time at which the second wireless communication unit 120 of the on-vehicle device 10 receives the first distance measurement signal to the time at which it transmits the second distance measurement signal.

To be more specific, the control unit 130 of the on-vehicle device 10 is able to calculate the time required for propagation of the first distance measurement signal and the second distance measurement signal (that is, the time required for round-trip communication) by subtracting the time ΔT2 from the time ΔT1, and is able to calculate the time required for propagation of either the first distance measurement signal or the second distance measurement signal (that is, the time required for one-way communication) by dividing such time by two.

Furthermore, the control unit 130 of the on-vehicle device 10 is able to calculate an estimation value of the distance between the on-vehicle device 10 and the portable device 20, that is, a distance measurement value by multiplying a value of (timeΔT1−timeΔT2)/2 by a signal speed.

Note that it is required to grasp the value of the time ΔT1 so that the control unit 130 of the on-vehicle device 10 calculates a distance measurement value. For this purpose, the control unit 230 of the portable device 20 may control the second wireless communication unit 220 to transmit the information related to the time ΔT1.

After completing the authentication at Step S302 and the distance measurement at Step S304, the control unit 130 of the on-vehicle device 10 determines whether or not to control a controlled device to perform specified processing.

Specifically, the control unit 130 of the on-vehicle device 10 determines whether or not it is estimated that the distance between the on-vehicle device 10 and the portable device 20 is within a specified range on the basis of the distance measurement result and the authenticity of the portable device 20 is recognized on the basis of the authentication result (S306).

Here, if the distance between the on-vehicle device 10 and the portable device is within a specified range and the authenticity of the portable device 20 is recognized (S306:Yes), the control unit 130 may control a controlled device to perform specified processing (S308).

Note that the controlled device according to the embodiment is, for example, a locking device that locks and unlocks the doors, an engine, or the like of the mobile body in which the on-vehicle device 10 is provided.

For example, if the distance between the on-vehicle device 10 and the portable device 20 is within a specified range and the authenticity of the portable device 20 is recognized, the control unit 130 of the on-vehicle device 10 of the embodiment may instruct the locking device to unlock the doors.

Moreover, for example, if the distance between the on-vehicle device 10 and the portable device 20 is within a specified range and the authenticity of the portable device 20 is recognized, the control unit 130 of the on-vehicle device 10 of the embodiment may permit the start of the engine.

With the control as described above, it is possible to control various kinds of processing in accordance with the distance between the on-vehicle device 10 and the portable device 20, in addition to the authentication of the portable device 20, and improve the security and enhance the convenience.

Meanwhile, if the distance between the on-vehicle device 10 and the portable device 20 is not within a specified range or the authenticity of the portable device 20 is not recognized (S306:No), the control unit 130 of the on-vehicle device 10 skips Step S308 and finishes the processing.

<2. Supplement>

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, the above-described embodiment has exemplified the case in which the portable device 20 transmits the first distance measurement signal and the on-vehicle device 10 transmits the second distance measurement signal. Meanwhile, the first distance measurement signal may be transmitted by the on-vehicle device 10, and the second distance measurement signal may be transmitted by the portable device 20.

Moreover, for example, the above-described embodiment has exemplified the case in which the on-vehicle device 10 performs distance measurement. Meanwhile, the distance measurement may be performed by the portable device 20. In this case, the on-vehicle device 10 may control a controlled device using a distance measurement value calculated by the portable device 20.

A sequence of processing by the devices described in this specification may be achieved using any one of software, hardware, and the combination of software and hardware. A program forming the software is preliminarily stored in, for example, a recording medium (non-transitory media) provided inside or outside each device. Then, each program is read in a random access memory (RAM) when executed by a computer, and executed by a processor such as a central processing unit (CPU). The above-described recording medium is, for example, a magnetic disk, an optical disk, a magneto-optical disk, a flash memory, or the like. Moreover, the above-described computer program may be distributed through a network, for example, without using any recording medium.

### REFERENCE SIGNS LIST

1 system
10 on-board unit
110 first wireless communication unit
120 second wireless communication unit
130 control unit
20 portable device
210 first wireless communication unit
220 second wireless communication unit
230 control unit

1. A wireless communication device, comprising:
a first wireless communication unit that performs first wireless communication with another communication device, the first wireless communication selectively using a plurality of channels complying with a first communication standard;
a second wireless communication unit that performs second wireless communication with the another communication device, the second wireless communication complying with a second communication standard different from the first communication standard; and
a control unit that controls the first wireless communication by the first wireless communication unit and the second wireless communication by the second wireless communication unit, wherein
the control unit controls the second wireless communication unit to start standby for receiving a signal used for the second wireless communication after a specified period of time, on the basis of reception of a connection request related to the first wireless communication by the first wireless communication unit.

2. The wireless communication device according to claim 1, wherein the control unit controls the first wireless communication unit to transmit timing information specifying timing at which the another communication device transmits a signal used for the second wireless communication, on the basis of reception of the connection request related to the first wireless communication by the first wireless communication unit.

3. The wireless communication device according to claim 2, wherein the control unit controls the first wireless communication unit to transmit the timing information using a channel different from a channel used for transmission of the connection request.

4. The wireless communication device according to claim 1, wherein the control unit controls the second wireless communication unit to transmit a second distance measurement signal in response to a first distance measurement signal received by the second wireless communication unit, and performs distance measurement based on the first distance measurement signal and the second distance measurement signal.

5. The wireless communication device according to claim 4, wherein the control unit controls a controlled device to perform specified processing if it is estimated that a distance between the wireless communication device and the another communication device is within a specified range on the basis of a result of the distance measurement and an authenticity of the another communication device is recognized on the basis of a result of authentication based on the first wireless communication.

6. The wireless communication device according to claim 5, wherein
the wireless communication device is provided in a mobile body, and
the control unit controls the controlled device provided in the same mobile body in which the wireless communication device is provided.

7. The wireless communication device according to claim 1, wherein the first wireless communication is BLE communication.

8. The wireless communication device according to claim 1, wherein the second wireless communication is UWB communication.

9. A wireless communication device, comprising:
a first wireless communication unit that performs first wireless communication with another communication device, the first wireless communication selectively using a plurality of channels complying with a first communication standard;
a second wireless communication unit that performs second wireless communication with the another communication device, the second wireless communication complying with a second communication standard different from the first communication standard; and
a control unit that controls the first wireless communication by the first wireless communication unit and the second wireless communication by the second wireless communication unit, wherein
the control unit controls timing at which the second wireless communication unit is controlled to transmit a signal used for the second wireless communication, on the basis of timing information received by the first wireless communication unit after the first wireless communication unit is controlled to transmit a connection request related to the first wireless communication.

10. The wireless communication device according to claim 9, wherein the wireless communication device is carried by a user.

11. A system, comprising:
a first wireless communication device; and
a second wireless communication device, wherein
the first wireless communication device includes
a first wireless communication unit that performs first wireless communication with the second communication device, the first wireless communication selectively using a plurality of channels complying with a first communication standard;
a second wireless communication unit that performs second wireless communication with the second communication device, the second wireless communication complying with a second communication standard different from the first communication standard; and
a control unit that controls the first wireless communication by the first wireless communication unit and the second wireless communication by the second wireless communication unit, wherein
the control unit controls the second wireless communication unit to start standby for receiving a signal used for the second wireless communication after a specified period of time, and controls the first wireless communication unit to transmit timing information specifying timing at which the second wireless communication device transmits a signal used for the second wireless communication, on the basis of reception of a connection request related to the first wireless communication by the first wireless communication unit, and
the second wireless communication device controls timing at which the signal used for the second wireless communication is transmitted, on the basis of the received timing information.

12. (canceled)

13. (canceled)
